(19) United States
(12) Patent Application Publication
(10) Pub. No.: US 2004/0014494 A1
(43) Pub. Date: Jan. 22, 2004

(54) Double wireless access point bridging system

(76) Inventors: Paul Hellhake, Downingtown, PA (US); Bruce Evans, Wayne, PA (US); Martin A. Lamb, Downingtown, PA (US); Joseph E. Parks, Coatesville, PA (US); Frank L. Pento, Holmdel, NJ (US); David J. Schena, Wayne, PA (US); Robert J. Schena, Wayne, PA (US); James Washington, Skillman, NJ (US)

Correspondence Address: Robert E. Cannuscio, DRINKER BIDDLE & REATH LLP, One Logan Square, 18th & Cherry Streets, Philadelphia, PA, 19103-6996, US

(21) Appl. No.: 10/197,326

(22) Filed: Jul. 16, 2002

(51) Int. Cl. H04B 1/38

(52) U.S. Cl. 455/555; 455/561

(57) ABSTRACT

A wireless communication network comprises a plurality of wireless communication nodes, each wireless communication node comprising a first wireless access point and a second wireless access point coupled to the first wireless access point. The first wireless access point is configured in a first mode to wirelessly communicate with at least one wireless client and with a wireless access point of another wireless communication node. The second wireless access point is configured to wirelessly communicate with a wireless access point of a different other wireless communication node. Multiple wireless communication nodes according the present invention may be coupled together to form a wireless bridged network.

### FIELD OF THE INVENTION

The invention pertains to wireless networking and, more particularly, to wireless bridged networking.

### BACKGROUND OF THE INVENTION

Communication systems connected by wire or fiber can be partially or completely disabled, by physical destruction, for example, in the event of a disaster. Thus, at a time of an emergency, when communication is most critical, the standard medium of communication at the site of the emergency may be unavailable. Further, in some circumstances, disaster strikes in a location where there is no preexisting communication system.

Establishing or re-establishing a wire- or fiber-based communication system may not be practical during an emergency when there is a need to quickly and inexpensively establish lines of communication. This is due, at least in part, to the physical burdens associated with routing wire or fiber, especially in a preexisting structure.

Some of the physical difficulties associated with establishing a wire- or fiber-based communication system may be avoided by instead deploying a wireless network. Cellular telephones utilize wireless networks to communicate but are often limited to voice communication and may become quickly saturated. An alternative to wireless telephone networks is a wireless network based upon IEEE Standard 802.11b, referred to herein as “an 802.11b network.”

As illustrated in FIG. 1, an 802.11b network 100 may include wireless clients (C) 102 (comprising network nodes equipped with a wireless network device or adapter) that communicate with wired networks 106, 112 via a wireless network access point (AP) 104. The AP 104 communicates with the wireless clients 102 via wireless links 110 and couples the wireless clients 102 to the wired network 106 via a wired connection 108. For convenience, wired links will be illustrated by solid lines and wireless links will be illustrated by dashed lines in the figures accompanying this application. The term “wired” includes not only conventional wire carrying electrical signals but also encompasses fiber optic cable carrying optical signals.

Wireless access points that are currently available may be configured to operate in one of four modes: Standard Access Point (AP); Access Point Client (AP-C); Point-to-Point Wireless Bridge (WB-PP); and Point-to-Multipoint Wireless Bridge (WB-PMP). The AP 104 in FIG. 1 is operating in the Standard Access Point mode. The AP 104 is coupled via a wireless link 116 to another wired network 112 via another access point 114. The AP 114 is configured in the Access Point Client (AP-C) mode and is coupled by a wired connection 118 to the wired network 112.

FIG. 2 illustrates a conventional 802.11b wireless network 200 using APs 202, 204 in the Point-to-Point Wireless Bridge mode. One access point WB-PP 202 is coupled to a wired network 206 via a wired connection 212. Another access point WP-PP 204 is coupled to another wired network 208 via a wired connection 214. The wired networks 206, 208 are “bridged” by a wireless link 210 between the two access points WB-PP 202, 204.

FIG. 3 illustrates a conventional 802.11b wireless network 300 using an AP 302 configured in the Point-to-Multipoint Wireless Bridge mode to wirelessly couple its corresponding wired network 304 to two other wired networks 306, 308. The access point WB-PMP 302 is coupled to its corresponding wired network 304 via a wired connection 316. The other access points WB-PP 310, 312 are configured in the Point-to-Point Wireless Bridge mode and are coupled to their respective wired networks 306, 308 by respective wired connections 318, 320. The wired networks 304, 306, 308 are “bridged” by wireless links 322, 324 coupling the point-to-point access points WB-PP 310, 312 to the point-to-multipoint access point WB-PMP 302.

As illustrated in FIGS. 1-3, conventional wireless 802.11b networks use access points with wired connections to wired networks. The access points couple the wired networks to other wired networks or to wireless clients.

There is a need for a wireless network that is simple and quick to install, flexible, inexpensive, and provides a bandwidth greater than that provided by voice networks. Further, there is a need for such wireless network to be wirelessly extendable without periodic connection to a wired network.

### SUMMARY OF THE INVENTION

In one aspect, the invention comprises a wireless communication node having a first wireless access point, a second wireless access point, and a base. The first wireless access point is configured in a first mode to wirelessly communicate with at least one wireless client. The second wireless access point is coupled to the first wireless access point and configured in a second mode to wirelessly communicate with a wireless access point of another wireless communication node. The first and second wireless access points are coupled to the base.

In another aspect, the invention comprises a wireless communication network including a plurality of wireless communication nodes, each having a first wireless access point and a second wireless access point. Each first wireless access point is configured in a first mode to wirelessly communicate with at least one wireless client. Each second wireless access point is coupled to the first wireless access point and configured in a second mode to wirelessly communicate with a wireless access point of a different one of the plurality of wireless communication nodes.

In another aspect, the invention comprises a method of creating a wireless communication network. The method includes the steps of configuring a plurality of wireless communication nodes whereby each of the plurality of wireless communication nodes is configured to communicate with at least one other of the plurality of wireless communication nodes. The wireless communication nodes are placed at selected locations responsive to a signal strength indicator on each of the plurality of wireless communication nodes.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIGS. 1 through 3 are block diagrams of conventional networks using wireless access points;

FIGS. 4A and 4B are block diagrams of wireless communication networks comprising a plurality of wireless communication nodes according to the present invention;

FIG. 5 is a flow chart illustrating a method of forming a wireless communication network according to the present invention;

FIG. 6 is a block diagram of a wireless communication network powered by an emergency lighting power grid according to the present invention; and

FIG. 7 is a block diagram of a wireless communication node according to the present invention.

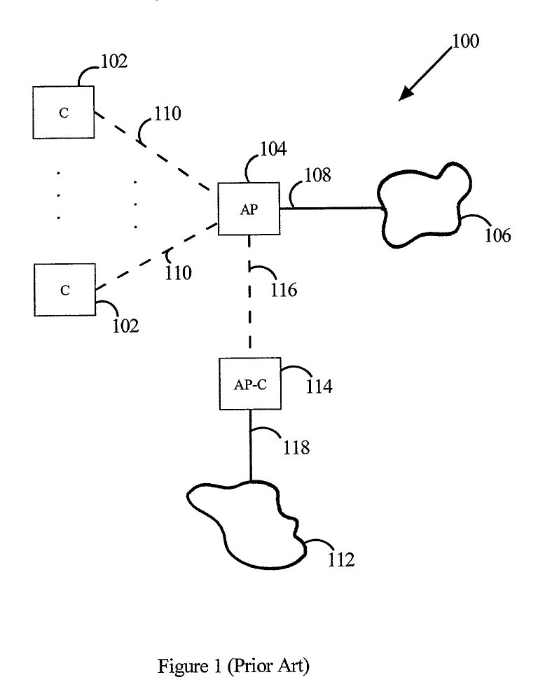

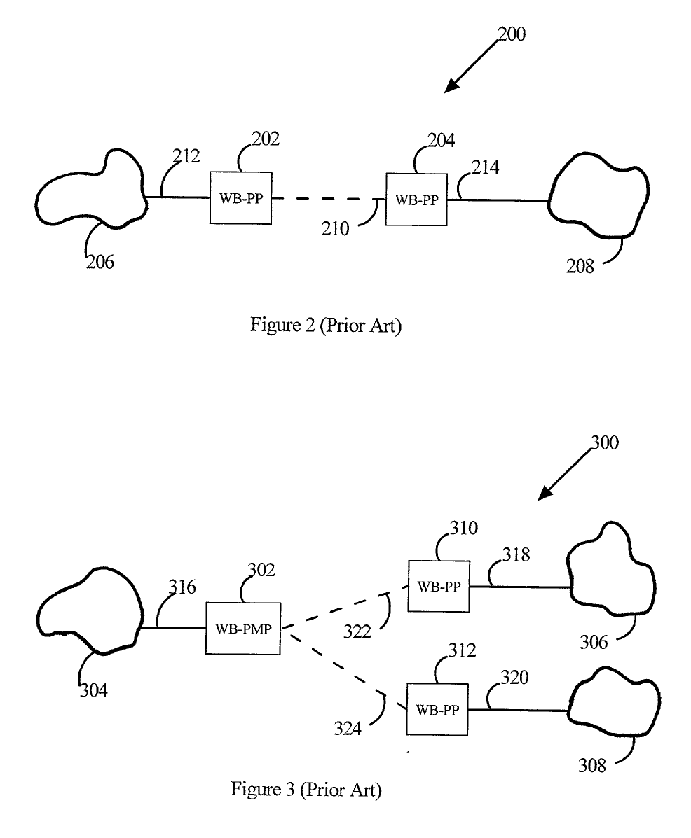

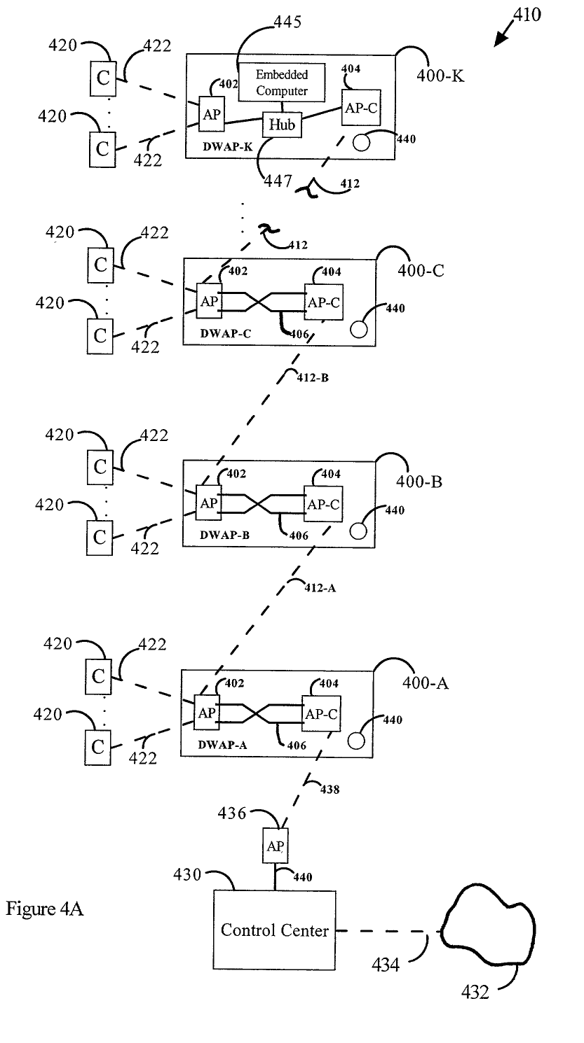

### DETAILED DESCRIPTION OF THE INVENTION

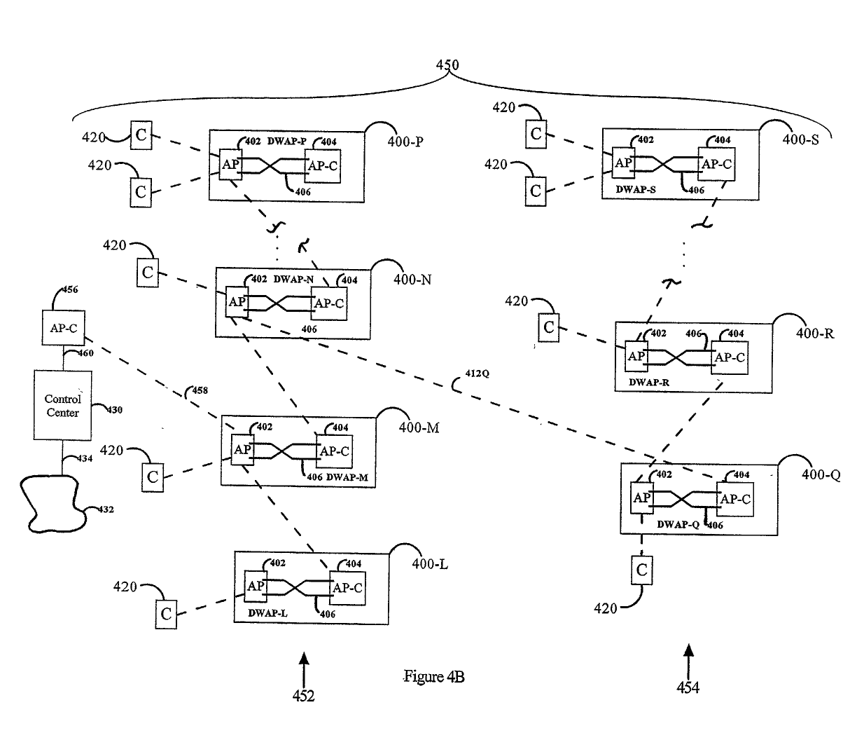

Referring to the drawings, in which like reference numerals indicate like elements, there is shown in FIG. 4A a plurality of wireless communication nodes 400 configured in a wireless bridged network 410 according to an exemplary embodiment of the present invention. The wireless communication nodes 400 are identified as DWAP-A (Double Wireless Access Point-A), DWAP-B, DWAP-C, through DWAP-K, referred to as 400-A, 400-B, 400-C, through 400-K, respectively.

A wireless communication node 400 comprises two wireless IEEE Standard 802.11b access points 402, 404. A first wireless access point 402 is configured in a Standard Access Point (AP) mode and a second wireless access point 404 is configured in an Access Point Client (AP-C) mode.

The first wireless access point AP 402 of a wireless communication node 400-B is configured to wirelessly communicate with wireless clients 420 via wireless links 422 and to wirelessly communicate with a second wireless access point AP-C 404 of another wireless communication node 400-C via a wireless link 412-B. The second wireless access point AP-C 404 of the wireless communication node 400-B is configured to communicate with the first wireless access point AP 402 of the same wireless access point 400-B via a wired cross-over connection 406 and to wirelessly communicate with a first access point 402 of another wireless communication node 400-A via another wireless link 412-A.

In this exemplary embodiment, the second access point AP-C 404 of a wireless communication node 400-B is preset to “home” to the first access point AP 402 of the other wireless communication node 400-A with which it communicates via the wireless link 412-A. The second access point AP-C 404 appears as a client (C) to the “home” access point AP 402. In other words, the second wireless access point AP-C 404 of a wireless communication node 400-B is preset to “home” to and to communicate as a client with a first wireless access point AP 402 of a preceding wireless communication node 400-A while the first wireless access point AP 402 of a succeeding wireless access node 400-C is set to “home” to and to communicate as a client with the first access point AP 402 of the wireless communication node 400-B.

In an exemplary embodiment, the first wireless access point AP 402 and the second wireless access point AP-C 404 of a wireless communication node 400 are manufactured as a single communication device capable of operating in two modes. One mode is the Standard Access Point AP mode and the other mode is the Access Point Client AP-C mode. The single communication device then functions as a wireless communication node 400 by alternately operating as the first access point AP 402 in the Standard Access Point mode and as the second access point AP-C 404 in the Access Point Client mode as needed to wirelessly communicate with wireless clients and/or other wireless communication nodes.

The wireless communication network 410 of FIG. 4A includes a control center 430 coupled to at least one of the wireless communication nodes 400 via an access point AP 436 operating in the Standard Access Point mode. The second access point AP-C 404 of a wireless communication node 400-A is set to “home” to the access point AP 436 and to communicate as a client with the access point AP 436 via a wireless link 438. The control center 430 may be coupled to the access point AP 436 via a wired link 440.

The control center 430 couples the wireless communication network 410 to an external network 432 via a communication path 434, which may be either wired or wireless. The control center 430 may couple the wireless communication network 410 to an external network such as the Internet via a satellite connection, microwave connection, or a wired connection as known to those skilled in the art. For example, the control center 430 may be coupled to the external network 432 via a TCP/IP (transmission control protocol/internet protocol) networking medium such as ethernet, 802.11b or other wireless protocols, fiber optic, satellite, or other technologies as they become commercially available and sufficiently cost-effective to include in the control center 430. These network connections 434 may be provided by network service vendors, the military, law enforcement agencies, or by offices with Internet connections that are proximate to the network 410 or control center 430 site and that they are willing to share to assist with disaster relief (or other) efforts.

In addition to coupling the wireless communication network 410 to an external network 432, the control center 430 may direct communication on the wireless communication network 410 by performing network control and administrative functions. For example, the control center 430 may initialize the wireless communication nodes 400. The control center 430 may also dynamically reconfigure the wireless communication nodes 400 in the event, for example, that one or more wireless communication nodes 400 fail to operate. The control center 430 may also authenticate the wireless clients 420 and may provide IP addresses to authorized wireless clients 420.

In an exemplary embodiment, the control center 430 will use SNMP (Simple Network Management Protocol) to remotely reconfigure the first access points APs 402 and the second access points AP-Cs 404 of the wireless communication nodes 400, and will provide IP addresses with default gateways pointing back to the control center 430 for authentication and authorization. Authentication and authorization can be based upon physical address information embedded within every device (MAC address) and/or a challenge-response mechanism such as requiring a username and password or an authorized key distributed through other means.

While the ability to reconfigure the wireless communication network 410 and implementation of authentication and authorization may be commercially attractive, the bridged wireless communication network 410 may function without these features. Further, the wireless communication network 410 may be implemented without a control center 430. For example, the access point 436 in FIG. 4A may be coupled directly to the external network 432 instead of via the control center 430. In such a network, basic services such as allocation of IP addresses and basic routing may be provided via other devices (such as clients C 420) anywhere on the wireless communication network 410 or on the external network 432. These services could also be incorporated directly into a wireless communication node 400 in the form of an embedded computer 445 connected to both the first access point AP 402 and the second access point AP-C 404 of a wireless communication node 400 via a hub 447 that would replace the cross-over connection 406 as illustrated in wireless communication node DWAP-K 400-K. When multiple wireless communication nodes 400 include such an embedded computer 445, those wireless communication nodes 400 may be configured with an algorithm for electing a leader to perform the services.

Embedded computers 445 in communication nodes 400 makes execution of applications possible. Distributed execution of applications on such embedded computers 445 allows for increased functionality without excessive consumption of available network bandwidth by reducing the amount of data transmitted to a central control unit. Embedded computers 445 may, for example, perform intrusion detection; distributed authentication where each wireless communication node 400 authenticates its own clients 420; or distributed encryption such that a wireless communication node 400 transmits data only to/from clients 420 that encrypt their communications or such that it encrypts any non-encrypted communications. Embedded computers 445 in wireless communication nodes 400 could also preprocess data to reduce data transmissions to a central control unit. For example, an embedded computer 445 could pre-process raw data from clients 420, such as sensors, or may calculate the distance of a wireless communication node 400 from a client 420, based on signal to noise ratio, for example, to calculate the location of a client 420 using similar information from other wireless communication nodes 400 and telemetry. As new applications are developed or required for a particular application, they may be downloaded to the embedded computers 445 for distributed execution.

FIG. 4B shows a plurality of wireless communication nodes 400 configured in a wireless bridged network 450 according to another exemplary embodiment of the present invention. The wireless communication nodes 400 are identified as DWAP-L, DWAP-M, DWAP-N, DWAP-P, DWAP-Q, DWAP-R, and DWAP-S, referred to as 400-L, 400-M, 400-N, 400-P, 400-Q, 400-R, and 400-S, respectively.

The wireless communication network 450 includes a first branch 452 comprising wireless communication nodes 400-L, 400-M, 400-N, and 400-P and a second branch 454 comprising wireless communication nodes 400-Q, 400-R, and 400-S. The wireless communication nodes 400 of each of the first branch 452 and the second branch 454 are coupled to each other in a fashion similar to the wireless communication nodes 400 of the wireless communication network 410 of FIG. 4A.

The second branch 454 is coupled to the first branch 452 by presetting the second access point AP-C 404 of a wireless communication node 400-Q of the second branch 454 to “home” to the first access point AP 402 of a wireless communication node 400-N of the first branch 452 with which it communicates via the wireless link 412-Q. The second access point AP-C 404 of DWAP-Q appears as a client (C) to the “home” access point AP 402 of DQAP-N. Additional branches comprising one or more wireless communication nodes 400 may be similarly configured to “home” to one or more first access points 402 of any other branch.

The wireless communication network 450 of FIG. 4B includes at least one control center 430 coupled to one of the wireless communication nodes 400-M via an access point AP-C 456 operating in the Access Point Client mode. The control center 430 is coupled to the access point AP-C 456 via a wired link 460. The access point AP-C 456 is set to “home” to the first access point 402 of any one of the plurality of wireless access points 400 of the wireless communication network 450 via a wireless link 458. The access point AP-C 456 appears as a client (C) to the “home” access point AP 402 of the wireless communication node (400-M in this embodiment). If communication with the wireless communication node 400-M is lost, due to a failure of the wireless communication node 400-M to operate or a blocked signal 458 path for example, the access point AP-C 456 may be reconfigured by the control center 430 to “home” to another one of the plurality of wireless communication nodes 400.

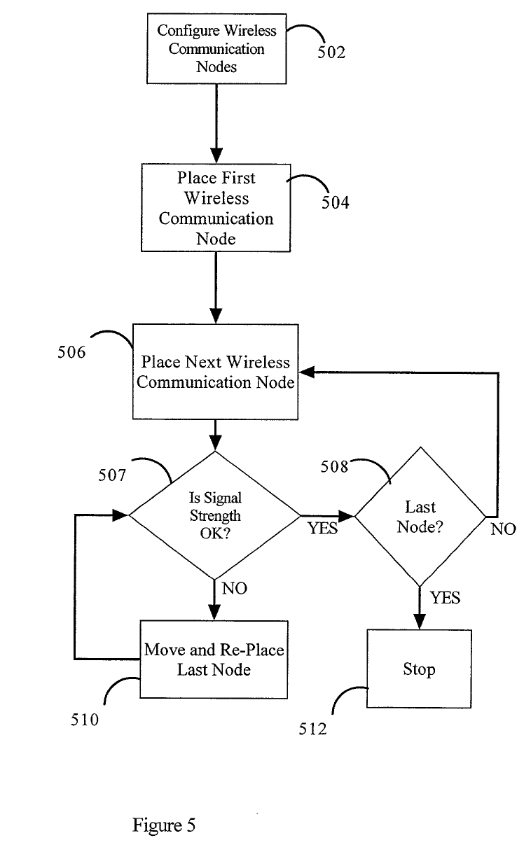

A method of forming a wireless communication network 410 according to the present invention is described with reference to the flow chart of FIG. 5. A plurality of wireless communication nodes 400 are coupled to and configured by a control center 430 (step 502). As illustrated above with reference to FIG. 4A, the wireless communication nodes 400 may be configured into a sequence of nodes having a first wireless communication node 400-A and a last wireless communication node 400-K. The second access point 404 of the first deployed wireless communication node 400-A is set to “home” to an access point 436 coupled to the control center 430, the second access point 404 of a second wireless communication node 400-B is set to “home” to the first access point 402 of the first wireless communication node 400-A, the second access point 404 of a third wireless communication node 400-C is set to “home” to the first access point 402 of the second wireless communication node 400-B, and so on.

In the case of an emergency, where a structure such as a building has lost its standard mode of communication, emergency service personnel may sequentially place the configured wireless communication nodes 400 through the building as follows to quickly form a wireless communication network throughout the building.

An emergency service person places the first of the plurality of wireless communication nodes 400-A within communication range of the access point 436 (step 504). The emergency service person then places the next sequential wireless communication node in the building within communication range of the preceding wireless communication node (step 506).

As illustrated in FIG. 4A, each wireless communication node 400 may include a signal strength indicator 440 for providing the emergency service person an indication of the strength of the wireless communication signal between the first access point AP 402 of the wireless communication node 400 being placed and the second access point AP-C 404 of the preceding wireless communication node 400. For example, the signal strength indicator 440 may signal with a green light to indicate sufficient signal strength and a red light to indicate poor signal strength. The emergency service person determines whether the signal strength is sufficient (step 507) by observing the signal strength indicator 440. If the emergency service person determines that the signal strength of the last-placed wireless communication node 400 is not sufficient (red light) (step 507), the emergency service person relocates (step 510) the last-placed wireless communication node 400 to a position where it can communicate with the preceding wireless communication node with sufficient signal strength and then again determines whether the signal strength is sufficient (step 507).

If the signal strength is sufficient (green light), the emergency service person determines whether the last placed wireless communication node was last sequential wireless communication node to be placed (step 508). If so, the physical placement of the network is complete (step 512). If not, the emergency service person proceeds to place the next successive wireless communication node (step 506) and continues as described above to test the signal strength (step 507).

In an exemplary embodiment, the wireless communication nodes 400 are configured to communicate only with other wireless communication nodes 400 at a preselected data rate such as at 11 Mbps. In such case, as the wireless communication nodes 400 are being sequentially placed to form a wireless communication network, the signal strength indicator 440 indicates whether communication with the preceding wireless communication node is at a data rate of 11 Mbps. In this way, high communication bandwidth of the wireless communication network 410 may be achieved by ensuring that communication between wireless communication nodes 400 is at the predetermined data rate.

In the event that a wireless communication node 400 fails to operate, wireless communication nodes 400 adjacent to the failed wireless communication node can be reconfigured to communicate with each other rather than through the failed wireless communication node 400. For example, with reference to FIG. 4A, if wireless communication node DWAP-B 400-B fails to operate, the second wireless access point AP-C 404 of wireless communication node DWAP-C 400-C may be reconfigured to “home” to wireless communication node DWAP-A 400-A. Upon losing a connection to either an immediately preceding or subsequent node, the configuration of a wireless communication node 400 is updated either by a computer (or control unit) coupled to the relevant second wireless access point, an embedded computer as described above, or by an automatic- or user-controlled administrative device on the wireless network 410, 450 that is capable of detecting the loss of connection or a reduction of the rate of communication below a preselected threshold. Although communication bandwidth may decrease and minimum bandwidth thresholds may need to be lowered to accommodate the loss of a node (because DWAP-A may be further away with respect to signal strength from DWAP-C than DWAP-B), network connectivity is maintained despite the failure of a wireless communication node 400.

To dynamically reconfigure a wireless communication network as described above, the wireless communication nodes 400 are arranged so each wireless communication node 400 can wirelessly communicate with more than one preceding and/or succeeding wireless communication node 400 rather than only one in each direction. In an exemplary embodiment, the wireless communication nodes 400 are positioned to and required to communicate with each other at a predetermined data rate (such as 11 Mbps). In the event that a node 400 fails to operate, the adjacent nodes (400-A and 400-C in the above example) are reconfigured to communicate with each other at a lower date rate if necessary. The signal strength indicator 440 may be adapted to provide an indication of the data rate such as different color signals for different data rates or an indication of the number of other wireless communication nodes 400 within communication range at any or at a particular data rate. Emergency service personnel may use such features to guide their placement of wireless communication nodes 400 to create a robust wireless communication network.

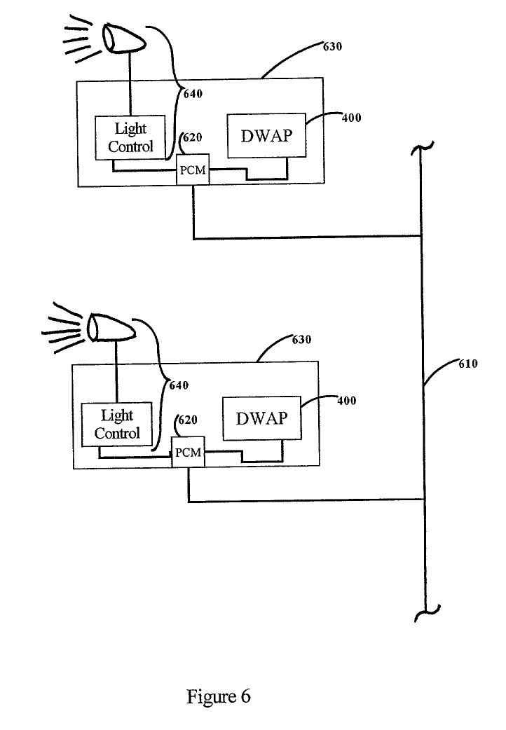

As illustrated in FIG. 6, a wireless communication network that is installed in a building may use the building's emergency lighting power grid 610 as its source of power. The emergency lighting power grid 610 may be coupled to the wireless communication node (DWAP) 400 via a power control module PCM 620 that includes a battery. The power control module 620 regulates power so the emergency lighting power grid 610 provides power to the wireless communication node 400 in a normal mode and the battery provides power to the wireless communication node 400 when power from the emergency lighting power grid 610 is not available.

The wireless communication nodes 400 may be configured to operate in an inactive (or stand-by) mode when power is supplied by the emergency lighting power grid 610 and then to operate in an active mode when power is supplied by the battery. Alternatively, wireless communication nodes 400 may operate in a normal active mode when power is being supplied by the emergency lighting power grid 610 and may operate in a emergency active mode when power is being supplied by the battery. In the normal active mode, all wireless clients may be permitted to communicate via the wireless communication network. In the emergency active mode, when it is desirable that nearly all bandwidth of the wireless communication network be allocated to emergency needs, the wireless communication network is configured to communicate with a select subset of the clients that have priority to use the wireless communication network for emergency purposes.

The power control module 620 may be a separate module as illustrated in FIG. 6 or may be integrated into a wireless communication node 400. An emergency lighting module 640 may be integrated with the power control module 620 and the wireless communication node 400 into a single wireless/lighting module 630. This wireless/lighting module 630 may then be used to replace existing emergency lighting modules 640 without building alteration in order to inexpensively retrofit an existing building with a wireless communication network.

In an exemplary embodiment, the wireless communication nodes 400 are remotely activated. A separate subsystem may be embedded within the wireless/lighting module 630 that supplies power to the DWAP 400 for a predetermined amount of time after detecting activity on certain frequencies.

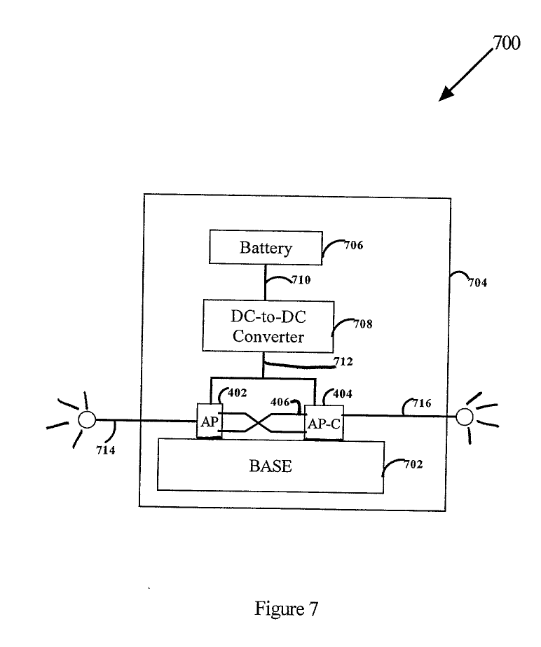

With reference to FIG. 7, a wireless communication node 700 may be a portable device and the first and second wireless access points 402, 404, having respective antennas 714, 716, may be mounted on a common base 702 as illustrated in FIG. 7. The wireless communication node 400 may be situated within an enclosure 704 to protect the wireless communication node 400 from environmental conditions. The base may be eliminated when an enclosure 704 is used and the first and second wireless access points 402, 404 may be mounted on an inside surface of the enclosure 704 or the base 702 may be fixably connected to the enclosure 704.

The wireless communication node 700 may include a battery 706 for providing power to the wireless access points 402, 404 and a DC-to-DC voltage converter 708 for converting the power signal 710 at the battery voltage to the DC input voltage requirement of the access points 402, 404 in the form of a converted power signal 712 if the battery voltage does not match such input DC voltage requirement. In an exemplary embodiment, the battery 706 sources power at a DC voltage of 12 volts and the DC-to-DC converter 708 converts the DC 12 volts sourced by the battery to DC 5 volts which it provides to the access points 402, 404.

The foregoing describes the invention in terms of embodiments foreseen by the inventors for which an enabling description was available, although insubstantial modifications of the invention, not presently foreseen may nonetheless represent equivalents thereto.

What is claimed is:

1. A wireless communication node comprising:
a. a first wireless access point configured in a first mode to wirelessly communicate with at least one wireless client;
b. a second wireless access point coupled to the first wireless access point and configured in a second mode to wirelessly communicate with a wireless access point of another wireless communication node; and
c. a base to which the first and second wireless access points are coupled.

2. The wireless communication node according to claim 1 wherein the second wireless access point is coupled to the first wireless access point by a wired crossover connection.

3. The wireless communication node according to claim 1 wherein the first wireless access point and the second wireless access point consist of a single communication device that alternates between operating as the first wireless access point and operating as the second wireless access point.

4. The wireless communication node according to claim 1 further comprising a signal strength indicator that provides an indication of a strength of a wireless signal between the wireless access point of the other wireless communication node and one of the first and second wireless access points.

5. The wireless communication node according to claim 1 further comprising a battery for providing power to the first and second wireless access points.

6. The wireless communication node according to claim 5 further comprising a DC-to-DC converter connected to the battery and to the first and second wireless access points for receiving power from the battery at a first voltage and providing power to the first and second wireless access points at a second voltage.

7. The wireless communication node according to claim 5 further comprising an emergency lighting module connected to the battery.

8. The wireless communication node according to claim 1 further comprising an enclosure containing the first and second access points.

9. A wireless communication network comprising a plurality of wireless communication nodes, each wireless communication node comprising:
a. a first wireless access point configured in a first mode to wirelessly communicate with at least one wireless client; and
b. a second wireless access point coupled to the first wireless access point and configured in a second mode to wirelessly communicate with a wireless access point of a different one of the plurality of wireless communication nodes.

10. The wireless communication network according to claim 9 wherein the first wireless access point and the corresponding second wireless access point of each of the plurality of wireless communication nodes are coupled together via a wired cross-over connection.

11. The wireless communication network according to claim 9 wherein at least one of said plurality of wireless communication nodes is coupled to a network external to the wireless communication network.

12. The wireless communication network according to claim 11 further comprising a control center coupled to the at least one of said plurality of wireless communication nodes to couple the at least one of said plurality of wireless communication nodes to the network external to the wireless communication network.

13. The wireless communication network according to claim 9 wherein at least one of the plurality of wireless communication nodes further comprises an embedded computer coupled to the first and second wireless access points for directing communication among the plurality of wireless communication nodes.

14. The wireless communication network according to claim 9 wherein each of the plurality of wireless communication nodes further comprises an embedded computer coupled to the first and second access points to enable distributed execution of applications.

15. The wireless communication network according to claim 9 further comprising a control center coupled to at least one of the plurality of wireless communication nodes for directing communication among the plurality of wireless communication nodes.

16. The wireless communication network according to claim 9 wherein the plurality of wireless communication nodes communicate with each other using IEEE standard 802.11b.

17. The wireless communication network according to claim 9 wherein at least one of the plurality of wireless communication nodes is configured to communicate with other wireless communication nodes only at a preselected data rate.

18. A wireless communication network according to claim 9 wherein at least one of the plurality of wireless communication nodes further comprises a control unit connected to its second wireless access point for detecting a rate of communication between the second wireless access point and the different one of the plurality of wireless communication nodes and reconfiguring the second wireless access point to wirelessly communicate with another different one of the plurality of wireless communication nodes in response to the rate of communication being below a preselected rate of communication.

19. The wireless communication network according to claim 9 further comprising an emergency lighting power grid coupled to provide power to the plurality of wireless communication nodes.

20. The wireless communication network according to claim 19 wherein each of the plurality of wireless communication nodes further comprises a battery connectable to it in response to an interruption in power from the emergency lighting power grid.

21. The wireless communication network according to claim 20 wherein each of the plurality of wireless communication nodes is configured to operate in an inactive mode when the wireless communicate node is supplied power by the emergency lighting power grid and to operate in an active mode when the wireless communicate node is supplied power by the battery.

22. A wireless communication network comprising a plurality of successive wireless communication nodes each coupled to an emergency lighting power grid, each wireless communication node comprising:
a. a first 802.11b wireless access point configured in a standard access point mode to wirelessly communicate with at least one wireless client;
b. a second 802.11b wireless access point coupled to the first 802.11b wireless access point via a cross-over connection and configured in an access point client mode to wirelessly communicate with an 802.11b wireless access point of a different one of the plurality of wireless communication nodes;
c. a control center coupled to at least one of said plurality of successive wireless communication nodes, wherein the control center directs communication among the plurality of successive wireless communication nodes;
d. a battery connectable to it in response to an interruption in power from the emergency lighting power grid; and
e. a signal strength indicator that indicates whether the strength of a wireless signal between one of the first and second 802.11b wireless access points and another one of the plurality of successive wireless communication nodes meets a predetermined threshold,
wherein at least one of said plurality of wireless communication nodes is configured to communicate with a network external to the wireless communication network and the plurality of successive wireless communication nodes are configured to communicate with other ones of the plurality of successive wireless communication nodes only at a preselected data rate.

23. A method of creating a wireless communication network comprising the steps of:
a. configuring a plurality of wireless communication nodes whereby each of the plurality of wireless communication nodes is configured to communicate with at least one other of said plurality of wireless communication nodes; and
b. placing the plurality of wireless communication nodes at locations selected in response to a signal strength indicator on each of the plurality of wireless communication nodes.

24. A method of forming a wireless communication network according to claim 23 wherein step (a) comprises configuring the plurality of wireless communication nodes into a sequential order of wireless communication nodes and step (b) comprises placing the plurality of wireless communication nodes in sequential order.
